(19) United States
(12) Patent Application Publication
(10) Pub. No.: US 2024/0349253 A1
(43) Pub. Date: Oct. 17, 2024

(54) RESOURCE ALLOCATION DEVICE, RESOURCE ALLOCATION METHOD, CONTROL CIRCUIT, AND STORAGE MEDIUM

(71) Applicant: Mitsubishi Electric Corporation, Tokyo (JP)

(72) Inventor: Daichi UCHINO, Tokyo (JP)

(73) Assignee: Mitsubishi Electric Corporation, Tokyo (JP)

(21) Appl. No.: 18/756,472

(22) Filed: Jun. 27, 2024

Related U.S. Application Data
(63) Continuation of application No. PCT/JP2022/005945, filed on Feb. 15, 2022.

(51) Int. Cl. H04W 72/04; H04W 72/51

(52) U.S. Cl. CPC H04W 72/04; H04W 72/51

(57) ABSTRACT

A resource allocation device includes: an information acquisition unit that acquires information regarding a slice requested by a target terminal which is a terminal as a target to which a slice is to be allocated, information regarding a base station to which the target terminal is to be connected, and information regarding a time at which a slice request is received from the target terminal, and stores the information in a storage unit; a data analysis unit that specifies a communication environment of the target terminal on the basis of information stored in the storage unit; and a slice allocation unit that allocates a slice to the target terminal on the basis of the communication environment of the target terminal.

### CROSS-REFERENCE TO RELATED APPLICATION

This application is a continuation application of International Application PCT/JP2022/005945, filed on Feb. 15, 2022, and designating the U.S., the entire contents of which are incorporated herein by reference.

### BACKGROUND OF THE INVENTION

### 1. Field of the Invention

The present disclosure relates to a resource allocation device, a resource allocation method, a control circuit, and a storage medium.

### 2. Description of the Related Art

In a 3rd generation partnership project (3GPP), which is a standardization organization for mobile communication systems, a communication method has been studied for an entire configuration of a system (hereinafter, also referred to as a “5G system”) including a wireless section called 5th generation (5G), and a core network and a wireless access network (hereinafter, collectively referred to as a network).

In order to provide enhanced mobile broadband (eMBB), ultra-reliable and low latency communication (URLLC), and machine-type communication (MTC) in the 5G system, 5G core network (5GCN) which is a new core network has been studied.

In the 5GCN, a network slice (hereinafter, also referred to as a slice) is defined, which is a logical network that provides a specific network function and specific network characteristics for a specific service type and a specific group.

In the 3GPP, enhancement of network slicing (eNS) has been studied to examine further functions related to network slices, and a function of managing the number of pieces of user equipment (UE, terminal devices) permitted to connect and the number of sessions to be connected is added for every slice. As a conventional technique related to this function, Japanese Patent Application Laid-open No. 2019-125847 discloses a technique for realizing management processing such as congestion management for every network slice.

In the 5G system, dual connectivity (DC) in which the UE is simultaneously connected to multiple base stations is possible. In a case of using the DC, in network slice selection assistance information (NSSAI), the UE notifies an access and mobility management function (AMF)/network slice selection function (NSSF) in the 5GCN of a slice desired to be connected, for every application (hereinafter, referred to as an app) for each of multiple cells to be connected. In the 5GCN, the UE is allocated to the slice on the basis of the NSSAI whose notification is provided.

However, since there is an upper limit to the number of connections of the UE for every slice, the UE may not be allocated to a requested slice. In this case, the UE needs to reselect another connectable cell and request allocation to the slice again. If there is no other connectable slice, the requested service cannot be used. In this way, when a case occurs in which the UE cannot be allocated to the slice, reselection of the cell or the like is required, and there is a problem in that reliability of the system is lowered, such as that time required for the service to be available becomes long or the service cannot be used.

### SUMMARY OF THE INVENTION

In order to solve the above-stated problems, a resource allocation device according to the present disclosure comprises: an information acquisition unit to acquire information and store the information in a storage unit, the information including information regarding a slice requested by a target terminal that is a terminal as a target to which a slice is to be allocated, information regarding a base station to which the target terminal is to be connected, and information regarding a time at which a request for a slice is received from the target terminal; a data analysis unit to specify a communication environment of the target terminal based on information stored in the storage unit; and a slice allocation unit to allocate a slice to the target terminal based on a communication environment of the target terminal.

### BRIEF DESCRIPTION OF THE DRAWINGS

FIG. 1 is a diagram illustrating an example of cell arrangement of a communication system to which a resource allocation device according to an embodiment is applied;

FIG. 2 is a diagram illustrating an example of a functional block configuration of a 5G system including a 5GCN that implements the communication system;

FIG. 3 is a sequence diagram illustrating an operation of registration on the 5GCN executed by a terminal in the communication system;

FIG. 4 is a diagram illustrating a configuration of data managed by a database;

FIG. 5 is a diagram illustrating an exemplary configuration of the resource allocation device;

FIG. 6 is a flowchart illustrating an example of an operation of the resource allocation device; and

FIG. 7 is a diagram illustrating an example of hardware for implementing the resource allocation device.

### DETAILED DESCRIPTION OF THE PREFERRED EMBODIMENTS

Hereinafter, a resource allocation device, a resource allocation method, a control circuit, and a storage medium according to embodiments of the present disclosure will be described in detail with reference to the drawings.

### Embodiment

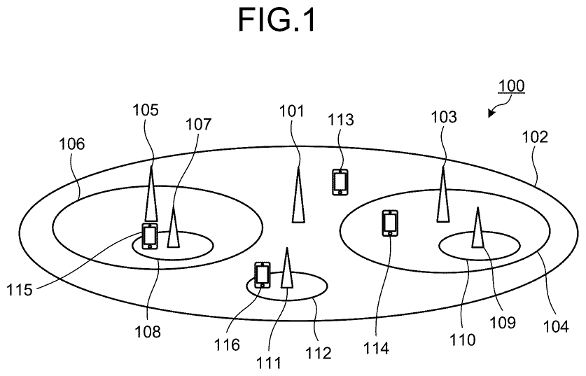

FIG. 1 is a diagram illustrating an example of cell arrangement of a communication system to which a resource allocation device according to an embodiment is applied. Here, a communication system 100 illustrated in FIG. 1 is a fifth generation (5G) mobile communication system. The resource allocation device according to the present embodiment constitutes a 5GCN (not illustrated in FIG. 1). That is, in FIG. 1, illustration of the resource allocation device according to the present embodiment is omitted.

The communication system 100 includes: a macrocell base station 101 that constitutes a coverage 102 that is a macrocell; a small cell base station 103 that constitutes a coverage 104 that is a small cell; a small cell base station 105 that constitutes a coverage 106 that is a small cell; a picocell base station 107 that constitutes a coverage 108 that is a picocell; a picocell base station 109 that constitutes a coverage 110 that is a picocell; and a picocell base station 111 that constitutes a coverage 112 that is a picocell.

In the coverage 102 of the macrocell base station 101, there are the small cell base stations 103 and 105 and the picocell base stations 107, 109 and 111. The coverages 104, 106, 108, 110, and 112 of these base stations are also present in the coverage 102 of the macrocell base station 101. Furthermore, the picocell base station 109 and the coverage 110 of the picocell base station 109 are present in the coverage 104 of the small cell base station 103. In the coverage 106 of the small cell base station 105, there are the picocell base station 107 and the coverage 108 of the picocell base station 107.

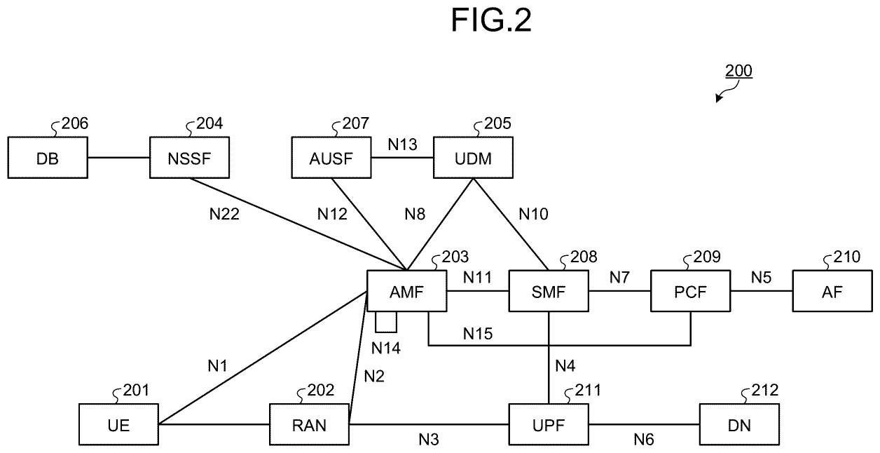

FIG. 2 is a diagram illustrating an example of a functional block configuration of a 5G system 200 including a 5GCN that implements the communication system 100.

As illustrated in FIG. 2, the 5G system 200 includes a UE 201, a radio access network (RAN) 202, an AMF 203, an NSSF 204, a unified data management (UDM) 205, a data base (DB) 206, an authentication server function (AUSF) 207, a session management function (SMF) 208, a policy control function (PCF) 209, an application function (AF) 210, and a user plane function (UPF) 211. The UE 201 corresponds to terminals 113, 114, 115, and 116 illustrated in FIG. 1. The RAN 202 includes one or more base stations, that is, each base station (the macrocell base station 101, the small cell base station 103 and 105, the picocell base station 107, 109, and 111) illustrated in FIG. 1. A data network (DN) 212 connected to the UPF 211 is an external network connected to the 5GCN.

In the 5G system 200, functions other than the DB 206 are functions standardized in the 3GPP, and processing similar to processing executed by functions having identical names in a general 5G system is executed. However, in order to solve the above-described problem, processing executed by the NSSF 204 is partially different from processing executed by the corresponding function of the conventional general 5G system. Furthermore, the DB 206 is a function added to solve the above-described problem, and includes an interface connected to the NSSF 204. Processing executed by the NSSF 204 and the DB 206 to solve the problem will be described later.

Returning to the description of FIG. 1, in the communication system 100, the four terminals 113 to 116 communicate with connectable base stations.

The terminal 113 is present inside the coverage 102, and can communicate with the macrocell base station 101. The terminal 114 is present inside the coverages 102 and 104, and can communicate with the macrocell base station 101 and the small cell base station 103. The terminal 115 is present inside the coverages 102, 106, and 108, and can communicate with the macrocell base station 101, the small cell base station 105, and the picocell base station 107. The terminal 116 is present inside the coverages 102 and 112, and can communicate with the macrocell base station 101 and the picocell base station 111.

In a case where each terminal communicates with a communicable base station, the terminal 113 transmits a registration request including NSSAI to the macrocell base station 101. In the NSSAI transmitted by the terminal 113, single-network slice selection assistance information (S-NSSAI) is described as identification information of a slice selected by an app operating on the terminal 113. In a case where multiple apps operating on the terminal 113 require a slice, the S-NSSAI is generated for every app and described in the NSSAI. That is, the NSSAI includes one or more pieces of the S-NSSAI.

Similarly, the terminal 114 transmits a registration request including the NSSAI to the macrocell base station 101 and the small cell base station 103. In the NSSAI transmitted by the terminal 114, the S-NSSAI is described as identification information of a slice selected by an app operating on the terminal 114. The terminal 115 transmits a registration request including the NSSAI to the macrocell base station 101, the small cell base station 105, and the picocell base station 107. In the NSSAI transmitted by the terminal 115, the S-NSSAI is described as identification information of a slice selected by an app operating on the terminal 115. The terminal 116 transmits a registration request including the NSSAI to the macrocell base station 101 and the picocell base station 111. In the NSSAI transmitted by the terminal 116, the S-NSSAI is described as identification information of a slice selected by an app operating on the terminal 116.

Here, it is assumed that each terminal holds in advance information such as what requirement the slice indicated by the S-NSSAI satisfies and what service the slice is suitable for use in. Therefore, the slice identification information S-NSSAI can also be said to be information regarding a type of the slice.

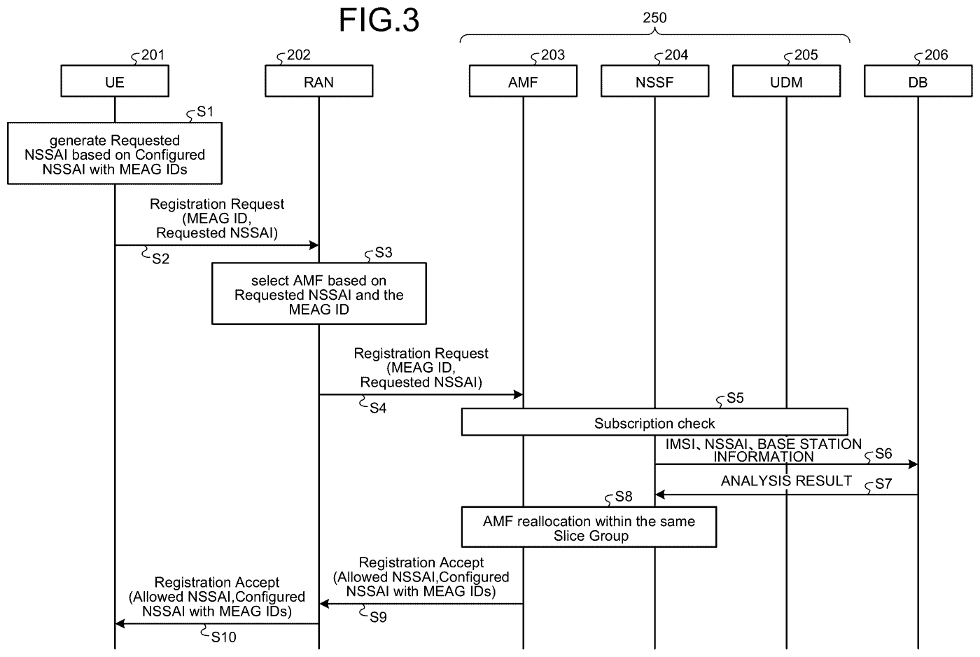

FIG. 3 is a sequence diagram illustrating an operation of registration on the 5GCN executed by the terminal 113 to 116 in the communication system 100. The operation of registration illustrated in FIG. 3 is obtained by adding the processing of steps S6 and S7 to an operation of registration in the conventional general 5G system. The processing of steps S1 to S5, S9, and S10 is common to a registration sequence in the conventional general 5G system. The processing in step S8 is partially different from the conventional processing.

When the UE 201 that is the terminal 113 to 116 satisfies a predetermined condition, the UE 201 generates information (requested NSSAI) indicating a network slice to be requested on the basis of a request for a network slice from an app, and transmits a registration request including the generated information (hereinafter, also referred to as request slice information) to the RAN 202 which is a base station (steps S1 and S2). The predetermined condition corresponds to, for example, a case where power of the UE 201 is turned ON, a case where it is necessary to change the base station to be connected in accordance with movement, and the like.

The RAN 202 selects an AMF on the basis of information included in the received registration request (step S3), and transmits the registration request to the selected AMF (AMF 203) in a 5GCN 250 (step S4).

When the AMF 203 receives the registration request, the AMF 203, the NSSF 204, and the UDM 205 perform subscription check (step S5), and provides international mobile subscriber identity (IMSI), NSSAI, and base station information from the NSSF 204 to the database (DB) 206 (step S6). The IMSI is identification information of the UE 201 that is a transmission source of the NSSI. The base station information is information related to the RAN 202 to which the UE 201 of the transmission source of the NSSI is connected.

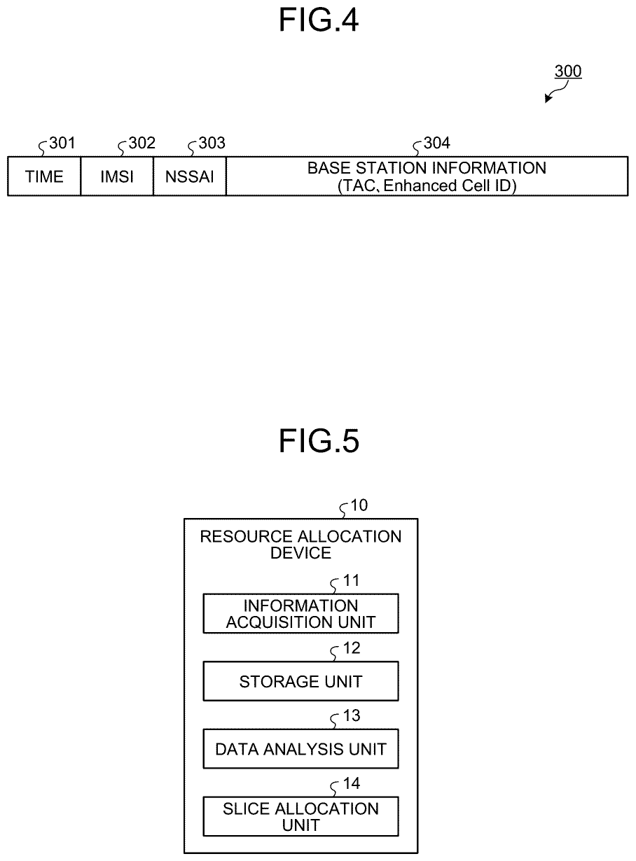

The database 206 stores individual pieces of information received from the NSSF 204 in a form illustrated in FIG. 4. FIG. 4 is a diagram illustrating a configuration of data managed by the database 206. As illustrated in FIG. 4, a record 300 managed by the database 206 includes TIME 301, IMSI 302, NSSAI 303, and base station information 304. The TIME 301 is information about a time at which the IMSI 302, the NSSAI 303, and the base station information 304 are received from the NSSF 204. The base station information 304 includes a tracking area code (TAC) and an Enhanced Cell ID.

After storing the information received in step S6 as the record 300, the database 206 analyzes the stored record 300 by a predetermined method, and transmits the result to the NSSF 204 (step S7). For example, the database 206 extracts the record 300 including the IMSI 302 having a value equal to the IMSI received in step S6, and transmits each extracted record 300 as an analysis result, in step S7.

The AMF 203 and the NSSF 204 select a slice to which the UE 201 is to be allocated on the basis of the analysis result received from the database 206 in step S7, and transmit information about the selected slice to the RAN 202 (Steps S8 and S9). In step S8, the NSSF 204 generates a slice as necessary, and allocates the slice to the UE 201. Upon receiving the information about the slice to be allocated to the UE 201 from the AMF 203, the RAN 202 transmits the received information to the UE 201 (step S10).

FIG. 5 is a diagram illustrating an exemplary configuration of a resource allocation device 10. The resource allocation device 10 includes an information acquisition unit 11, a storage unit 12, a data analysis unit 13, and a slice allocation unit 14. The resource allocation device 10 is a device that implements the NSSF 204 and the DB 206 in the 5GCN of the 5G system 200 illustrated in FIG. 2. That is, the resource allocation device 10 allocates a slice in response to a request from the UE 201. Note that, in the present embodiment, a case will be described in which the NSSF 204 and the DB 206 are implemented by one resource allocation device 10, but the NSSF 204 and the DB 206 may be implemented by different devices.

The information acquisition unit 11 acquires information necessary for processing of allocating a slice to a terminal, specifically, identification information (IMSI) about the terminal, information (NSSAI) regarding a slice requested by the terminal, and information about a base station to which the terminal is to be connected.

The storage unit 12 stores the information acquired by the information acquisition unit 11 together with acquired time information. The storage unit 12 stores individual pieces of information in association with each other in a form illustrated in FIG. 4.

The data analysis unit 13 analyzes the information stored in the storage unit 12, and specifies a communication environment of a terminal of a request source of the slice

The slice allocation unit 14 allocates a slice to the terminal on the basis of the communication environment of the terminal specified by the data analysis unit 13.

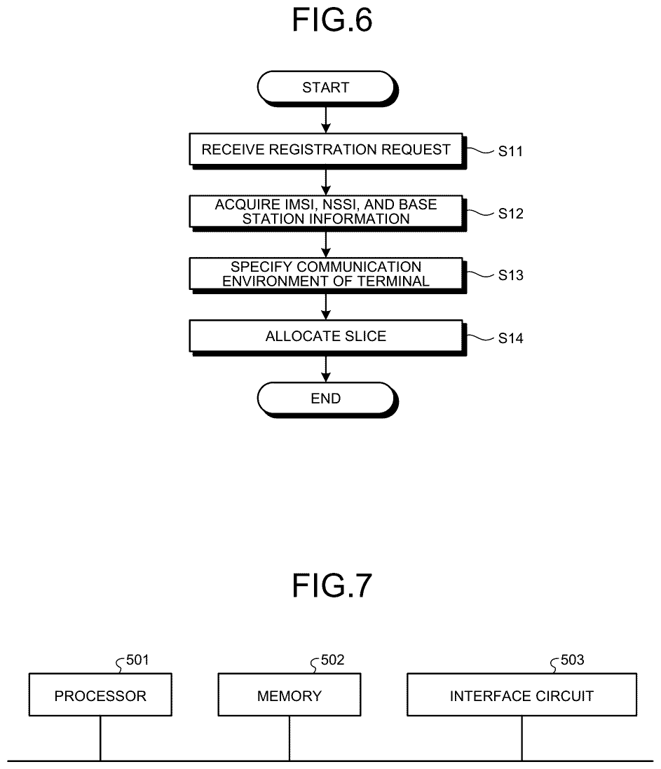

The resource allocation device 10 illustrated in FIG. 5 allocates a slice to the terminal in accordance with a flowchart illustrated in FIG. 6. FIG. 6 is a flowchart illustrating an example of an operation of the resource allocation device 10.

First, the resource allocation device 10 receives a registration request including the NSSAI from the terminal (step S11).

Next, the resource allocation device 10 acquires the IMSI, the NSSI, and the base station information of the terminal of the transmission source of the registration request received in step S11 (step S12). In step S12, the information acquisition unit 11 acquires the IMSI, the NSSI, and the base station information, and stores a time at which these pieces of information have been acquired, that is, information about the reception time (TIME) of the registration request, into the storage unit 12 in association with each of the acquired pieces of information

Next, the resource allocation device 10 specifies a communication environment of a terminal (hereinafter, also referred to as a target terminal) as a target to which a slice is to be allocated (step S13). For example, a cell to which the target terminal can be connected and a base station constituting the cell are specified. Specifically, the data analysis unit 13 analyzes the TIME, the IMSI, and the base station information stored in the storage unit 12, and specifies the cell to which the target terminal can be connected and the base station constituting the cell.

Next, the resource allocation device 10 allocates a slice to the target terminal (step S14). Specifically, the slice allocation unit 14 allocates the slice on the basis of the communication environment of the target terminal.

A specific example of a method in which the resource allocation device 10 allocates a slice will be described with reference to FIG. 1.

In the communication system 100 of FIG. 1, it is assumed that the number of terminals (pieces of UE) that can be accommodated by a macrocell base station is larger than that of a small cell base station, and the number of terminals that can be accommodated by a small cell base station is larger than that of a picocell base station.

In the communication system 100, for example, the terminal 115 connected to multiple cells exchanges a control-plane (C-Plane) with the macrocell base station 101, the small cell base station 105, and the picocell base station 107. Since the number of terminals that can be accommodated by the macrocell base station 101 is larger than that of the small cell base station 105, and the number of terminals that can be accommodated by the small cell base station 105 is larger than that of the picocell base station 107, wireless resources of the macrocell base station 101 are tight due to connection of the large number of terminals. Whereas, since the number of terminals that can be accommodated by the picocell base station 107 is small, there is room for wireless resources. In this case, it is desirable to allocate a slice to the terminal 115 via the picocell base station 107 having room for wireless resources. In this way, efficient use of wireless resources in the entire system can be achieved. Therefore, in the resource allocation device 10, by checking the TAC and the Enhanced Cell ID included in the base station information stored in the storage unit 12, the data analysis unit 13 specifies a type of a base station to which the target terminal as a target to which the slice is to be allocated can be connected, and the slice allocation unit 14 preferentially allocates a slice via a base station having a small number of terminals that can be accommodated. For example, in a case where a picocell base station is included in the base stations to which the terminal (target terminal) as the target to which a slice is to be allocated can be connected, the slice allocation unit 14 allocates a slice via the picocell base station to the target terminal. In a case where the base stations to which the target terminal can be connected include a small cell base station but does not include a picocell base station, the slice allocation unit 14 allocates a slice via the small cell base station to the target terminal. By allocating the slice in this manner, it is possible to prevent frequent occurrence of slices in a non-allocatable state, and it is possible to achieve effective use of wireless resources.

Note that the data analysis unit 13 specifies the type of the base station to which the target terminal can be connected, on the basis of the information (TAC, Enhanced Cell ID) about the base station that has received the NSSAI from the target terminal during a period from a certain time point in the past to the current time point. The data analysis unit 13 checks, for example, information about the base station that has received the NSSAI from the target terminal during a period from 100 ms ago to the current time point, and specifies the type of the base station to which the target terminal can be connected.

A first other method in which the resource allocation device 10 allocates a slice will be described.

In the resource allocation device 10, the data analysis unit 13 calculates a usage status of a slice for each terminal, that is, which slice is used for how long by each terminal, on the basis of individual pieces of information stored in the storage unit 12. The slice allocation unit 14 performs control such as allocating a slice preferentially to a target terminal having long connection time with a slice or allocating a slice preferentially to a target terminal having short connection time with a slice, on the basis of the usage status of the slice for each terminal. For example, in a case where an identical slice is requested from a plurality of target terminals at an identical timing, but the slices can be allocated to only some target terminals, the slice allocation unit 14 determines a target terminal to which a slice is to be allocated on the basis of the slice usage status of each target terminal.

A second other method in which the resource allocation device 10 allocates a slice will be described.

In the resource allocation device 10, the data analysis unit 13 determines whether a type of a handover cell is a macrocell, a small cell, or a picocell on the basis of information about a base station constituting a cell subjected to handover by the target terminal among the information stored in the storage unit 12, and estimates a moving speed of the target terminal on the basis of time from the handover to next handover of the target terminal and the type of the cell. Note that, since a rough coverage of the cell can be known from the type of the cell, the moving speed can be estimated from a time interval at which the handover is performed and the type of the cell connected at the time of performing the handover. The slice allocation unit 14 allocates the slice on the basis of the moving speed. For example, in a case where there are multiple connectable base stations and a slice is to be allocated to a target terminal having a higher moving speed than a predetermined threshold, a slice via a base station having a large coverage of a constituent cell is preferentially allocated. For example, the slice allocation unit 14 allocates a slice via a macrocell base station to the target terminal if it is possible to allocate the slice via the macrocell base station, and allocates a slice via a small cell base station if it is not possible to allocate the slice via the macrocell base station. If allocation of the slice via the small cell base station is not possible, the slice via the picocell base station is allocated. As a result, the number of times of handover execution can be reduced, and a processing load and the number of times of control message transmission and reception can be reduced. Note that, instead of estimating the moving speed of the target terminal, the data analysis unit 13 may obtain a frequency of switching a connection destination base station by the target terminal, for example, the number of times of handover execution in past fixed time. The slice allocation unit 14 preferentially allocates a slice via a base station having a large coverage of a constituent cell, to a target terminal having a larger frequency of switching the connection destination base station than a predetermined threshold.

In a case of allocating a slice to a target terminal for which multiple connectable base stations are present, the slice allocation unit 14 may preferentially allocate a slice via a base station having a small coverage of a constituent cell to the target terminal, in a case where the moving speed of the target terminal is equal to or less than a predetermined threshold or in a case where a frequency of switching the connection destination base station is equal to or less than a predetermined threshold.

A third other method in which the resource allocation device 10 allocates a slice will be described.

In some slices generated in the 5G system, multiple slices corresponding to an identical type of request cannot be occupied by one terminal. That is, there are slices that cannot be allocated to one terminal even if there are multiple slices of an identical type. Such a slice is referred to as an exclusive slice.

In the resource allocation device 10, the data analysis unit 13 analyzes the information stored in the storage unit 12, and determines whether there are multiple base stations to which the target terminal can be connected and whether the requested slice corresponds to the exclusive slice. In a case where there are multiple base stations to which the target terminal can be connected and the requested slice is the exclusive slice, the slice allocation unit 14 preferentially allocates a slice via a base station constituting a cell with a small coverage, which is a cell having a small number of terminals that can be accommodated, to the target terminal. This enables effective use of wireless resources.

Next, hardware for implementing the resource allocation device 10 will be described. FIG. 7 is a diagram illustrating an example of hardware for implementing the resource allocation device 10. The resource allocation device 10 can be implemented by a processor 501, a memory 502, and an interface circuit 503 illustrated in FIG. 7.

The processor 501 is a central processing unit (CPU) (may also be referred to as a central processing device, a processing unit, an arithmetic unit, a microprocessor, a microcomputer, or a digital signal processor (DSP)), a system large scale integration (LSI), or the like. The memory 502 is a random access memory (RAM), a read only memory (ROM), an erasable programmable read only memory (EPROM), an electrically erasable programmable read only memory (EEPROM, registered trademark), a hard disk drive, or the like. The interface circuit 503 is a circuit for the resource allocation device 10 to exchange data with another device, for example, a network device constituting the 5GCN.

The information acquisition unit 11, the data analysis unit 13, and the slice allocation unit 14 of the resource allocation device 10 are implemented by the processor 501 executing a program for operating as these units. The program for operating as the information acquisition unit 11, the data analysis unit 13, and the slice allocation unit 14 is stored in the memory 502 in advance. The processor 501 operates as the information acquisition unit 11, the data analysis unit 13, and the slice allocation unit 14 by reading the above-described program from the memory 502 and executing the program. Furthermore, the storage unit 12 is implemented by the memory 502.

Note that, the program for operating as the information acquisition unit 11, the data analysis unit 13, and the slice allocation unit 14 is stored in the memory 502 in advance, but the present disclosure is not limited thereto. The program described above is supplied to the user of the resource allocation device 10 in a state of being written in a recording medium such as a compact disc (CD)-ROM or a digital versatile disc (DVD)-ROM, and a user may install the program in the memory 502. In this case, the hardware implementing the resource allocation device 10 further includes a reading device for reading the program from the recording medium. The reading device may be connected to the interface circuit 503 to install the program.

Furthermore, the hardware illustrated in FIG. 7 is for implementing the information acquisition unit 11, the data analysis unit 13, and the slice allocation unit 14 of the resource allocation device 10 by the general-purpose processor 501 and the memory 502, but the information acquisition unit 11, the data analysis unit 13, and the slice allocation unit 14 of the resource allocation device 10 may be implemented by dedicated processing circuitry instead of the processor 501 and the memory 502. The dedicated processing circuitry is a single circuit, a composite circuit, an application specific integrated circuit (ASIC), a field-programmable gate array (FPGA), or a combination of these. Note that some of the information acquisition unit 11, the data analysis unit 13, and the slice allocation unit 14 may be implemented by the dedicated processing circuitry, and the rest may be implemented by the processor 501 and the memory 502 illustrated in FIG. 7.

As described above, when a slice is requested from a terminal, the resource allocation device 10 according to the present embodiment stores, in the storage unit 12 in association with each other, identification information of the terminal of the request source, identification information of the requested slice, information about the base station to which the terminal is to be connected, and information about a time at which the request is received, and the slice allocation unit 14 allocates the slice to the terminal on the basis of a communication environment of the terminal obtained by the data analysis unit 13 analyzing the information stored in the storage unit 12. For example, the slice allocation unit 14 preferentially allocates a slice via a base station having a small number of terminals that can be accommodated, among base stations to which the terminal of the slice request source can be connected. As a result, it is possible to reduce a frequency of occurrence of a terminal to which a slice cannot be allocated, and it is possible to effectively use wireless resources. Furthermore, reliability of the communication system 100 can be enhanced.

The resource allocation device according to the present disclosure has an effect of being able to improve reliability of a communication system.

The configuration illustrated in the above embodiment illustrates one example and can be combined with another known technique, and it is also possible to omit and change a part of the configuration without departing from the subject matter.

What is claimed is:

1. A resource allocation device comprising:
information acquisition circuitry to acquire information and store the information in a memory, the information including information regarding a slice requested by a target terminal that is a terminal as a target to which a slice is to be allocated, information regarding a base station to which the target terminal is to be connected, and information regarding a time at which a request for a slice is received from the target terminal;
data analysis circuitry to specify a communication environment of the target terminal based on information stored in the memory; and
slice allocation circuitry to allocate a slice to the target terminal based on a communication environment of the target terminal, wherein
the data analysis circuitry specifies a type of a base station to which the target terminal can be connected, by analyzing information acquired by the information acquisition circuitry in a past specific period among information stored in the memory, and
the slice allocation circuitry allocates, to the target terminal, a slice via a base station selected from base stations of a type specified by the data analysis circuitry.

2. The resource allocation device according to claim 1, wherein
in a case where there are multiple base stations to which the target terminal can be connected, the slice allocation circuitry preferentially allocates, to the target terminal, a slice via a base station having a smaller number of terminals that can be accommodated.

3. The resource allocation device according to claim 1, wherein
in a case where there are multiple base stations to which the target terminal can be connected, the slice allocation circuitry preferentially allocates, to the target terminal, a slice via a base station constituting a cell having a smaller coverage.

4. The resource allocation device according to claim 1, wherein
the data analysis circuitry calculates a frequency of switching a connection destination base station by the target terminal based on information stored in the memory, and
in a case where there are multiple base stations to which the target terminal can be connected, and a frequency of switching a connection destination base station by the target terminal is larger than a predetermined threshold, the slice allocation circuitry preferentially allocates, to the target terminal, a slice via a base station constituting a cell having a larger number of terminals that can be accommodated.

5. The resource allocation device according to claim 1, wherein
the data analysis circuitry calculates a frequency of switching a connection destination base station by the target terminal, based on information stored in the memory, and
in a case where there are multiple base stations to which the target terminal can be connected, and a frequency of switching a connection destination base station by the target terminal is larger than a predetermined threshold, the slice allocation circuitry preferentially allocates, to the target terminal, a slice via a base station constituting a cell having a larger coverage.

6. The resource allocation device according to claim 1, wherein
the data analysis circuitry determines whether or not a slice requested by the target terminal corresponds to an exclusive slice, based on information stored in the memory, and
in a case where there are multiple base stations to which the target terminal can be connected, and a slice requested by the target terminal is an exclusive slice, the slice allocation circuitry preferentially allocates, to the target terminal, a slice via a base station constituting a cell having a smaller coverage.

7. A resource allocation method for a resource allocation device to allocate a slice to a terminal in a communication system, the resource allocation method comprising:
an information acquisition of acquiring information and storing the information in a memory, the information including information regarding a slice requested by a target terminal that is a terminal as a target to which a slice is to be allocated, information regarding a base station to which the target terminal is to be connected, and information regarding a time at which a request for a slice is received from the target terminal;
a data analysis of specifying a communication environment of the target terminal based on information stored in the memory; and
a slice allocation of allocating a slice to the target terminal based on a communication environment of the target terminal, wherein
in the data analysis, a type of a base station to which the target terminal can be connected is specified by analyzing information acquired in the information acquisition in a past specific period among information stored in the memory, and
in the slice allocating, a slice via a base station selected from base stations of a type specified in the data analyzing is allocated to the target terminal.

8. A control circuit for controlling a resource allocation device that allocates a slice to a terminal in a communication system, the control circuit causing the resource allocation device to execute:
an information acquisition of acquiring information and storing the information in a memory, the information including information regarding a slice requested by a target terminal that is a terminal as a target to which a slice is to be allocated, information regarding a base station to which the target terminal is to be connected, and information regarding a time at which a request for a slice is received from the target terminal;
a data analysis of specifying a communication environment of the target terminal based on information stored in the memory; and
a slice allocation of allocating a slice to the target terminal based on a communication environment of the target terminal, wherein
in the data analysis, a type of a base station to which the target terminal can be connected is specified by analyzing information acquired in the information acquisition in a past specific period among information stored in the memory, and
in the slice allocating, a slice via a base station selected from base stations of a type specified in the data analyzing is allocated to the target terminal.

9. A non-transitory storage medium for storing a program, the program being for controlling a resource allocation device that allocates a slice to a terminal in a communication system, wherein
the program causes the resource allocation device to execute:
an information acquisition of acquiring information and storing the information in a memory, the information including information regarding a slice requested by a target terminal that is a terminal as a target to which a slice is to be allocated, information regarding a base station to which the target terminal is to be connected, and information regarding a time at which a request for a slice is received from the target terminal;
a data analysis of specifying a communication environment of the target terminal based on information stored in the memory; and
a slice allocation of allocating a slice to the target terminal based on a communication environment of the target terminal, wherein
in the data analysis, a type of a base station to which the target terminal can be connected is specified by analyzing information acquired in the information acquisition in a past specific period among information stored in the memory, and
in the slice allocating, a slice via a base station selected from base stations of a type specified in the data analyzing is allocated to the target terminal.
